(19) United States
(12) Patent Application Publication
(10) Pub. No.: US 2004/0067400 A1
(43) Pub. Date: Apr. 8, 2004

(54) Fuel cell assembly

(76) Inventor: Marc Steinfort, Ismaning (DE)

Correspondence Address: CROWELL & MORING LLP, INTELLECTUAL PROPERTY GROUP, P.O. BOX 14300, WASHINGTON, DC, 20044-4300, US

(21) Appl. No.: 10/416,729

(22) PCT Filed: Nov. 13, 2001
(86) PCT No.: PCT/EP01/13089

(30) Foreign Application Priority Data
Nov. 15, 2000 (DE) 100 56 536.0

(51) Int. Cl. H01M 8/04

(52) U.S. Cl. 429/26; 429/38

(57) ABSTRACT

The invention relates to a fuel cell assembly with fuel cells arranged in the form of a fuel cell stack (310). The fuel cell assembly disposes of an anode inlet (313) and of an anode outlet (314) for the combustion gas and disposes of a cathode inlet (315) and of a cathode outlet (316) for the cathode gas. An electric heating device (320) is provided for heating the gas stream consisting of cathode gas and/or of combustion gas. According to the invention, the electric heating device (320) is formed by a structure, which is comprised of an electrically conductive foam material, through which gas to be heated flows, and which is provided with electric connections to the connection of a power supply.

The invention pertains to a fuel cell arrangement in accordance with the preamble of claim 1. Fuel cell arrangements are known with fuel cells that are arranged in the form of a fuel cell stack, whereby the fuel cells each contain an anode, a cathode, and an electrolyte matrix that is arranged between them. The fuel cell arrangement is provided with an anode inlet for admitting fresh fuel gas to the anodes, and with an anode outlet for carrying away spent fuel gas from the anodes, together with a cathode inlet for admitting fresh cathode gas to the cathodes, and with a cathode outlet for carrying away spent cathode gas from the cathodes. An electrical heating device serves for heating the cathode inlet gas, e.g. when starting up the fuel cell arrangement.

In addition, fuel cell arrangements of this type are known in which one or more fuel cell stacks are arranged in a thermally insulating protective housing that surrounds the flow pathways of the cathode gas and the fuel gas, whereby the fuel cell stack(s) and the electrical heating device are linked together and are arranged in amalgamated form in the thermally insulating protective housing.

In the case of fuel cell arrangements of the indicated type, it is also known that a catalytic combustion device can be provided, which is connected to the anode outlet and arranged downstream thereof, for after-burning the combustible residual components of the spent fuel gas that leaves the anode outlets.

The objective of the invention is to create an improved fuel cell arrangement. This objective is accomplished by the fuel cell arrangement that is indicated in claim 1.

Advantageous further developments of the fuel cell arrangement in accordance with the invention are characterized in the subsidiary claims.

A fuel cell arrangement with fuel cells arranged in the form of a fuel cell stack is created by means of the invention, whereby the fuel cells each contain an anode, a cathode, and an electrolyte matrix that is arranged between them. In addition, the fuel cell arrangement has an anode inlet for admitting fresh fuel gas to the anodes, and an anode outlet for carrying away spent fuel gas from the anodes. A cathode inlet is provided for admitting fresh cathode gas to the cathodes and a cathode outlet serves for carrying away spent cathode gas from the cathodes. Finally, an electrical heating device is provided in order to heat the cathode inlet gas. In accordance with the invention, the feature is provided that the electrical heating device is formed from a structure comprising an electrically conducting foam material, whereby the gas, which is to be heated, flows through this structure, and whereby this structure is provided with electrical connections for connection to a supply of electric current.

In accordance with a preferred form of design of the invention, the foam structure of the electrical heating device comprises high grade steel, preferably FeCrAlY, or steel, or a conducting ceramic.

In accordance with an especially advantageous form of design of the invention, the heating device comprises several individual segments that have each been provided with electrical connections, whereby the gas, which is to be heated, flows through these segments.

In accordance with an advantageous further development hereof, the segments of the heating device are arranged at different locations within the gas stream that is to be heated.

In accordance with an advantageous further development, the segments of the heating device have connections, which are each electrically separated from one another, whereby these connections are capable of being connected—separately from one another as required—to the supply of electric current.

The electrical heating device is preferably arranged in the gas stream prior to the cathode inlet in order to heat the cathode gas that is to be admitted to the cathodes of the fuel cells. In accordance with an advantageous further development hereof, the anode outlet is connected to the cathode inlet via a gas-carrying pathway in order to admit at least a portion of the spent fuel gas to the cathodes, and the electrical heating device is arranged in the gas carrying pathway after the anode outlet and prior to the cathode inlet.

This is preferably developed further by way of the feature that a mixing chamber is provided in which, prior to admission to the cathode inlet, the cathode gas is mixed in with the stream of spent fuel gas that leaves the anode outlet, whereby this mixing chamber is provided in the gas carrying pathway between the anode outlet and the cathode inlet, and by the feature that the electrical heating device is arranged, together with the mixing chamber, in the gas stream between the anode outlet and the cathode inlet.

In accordance with one form of design of the invention, the electrical heating device is arranged directly prior to the cathode inlet.

In accordance with an especially advantageous further development hereof, the foam structure of the electrical heating device occupies essentially the entire cross-section of the cathode inlets of all the fuel cells in the fuel cell stack.

In accordance with an alternative form of design, the feature is provided that the electrical heating device is arranged at the outlet of the mixing chamber.

In accordance with another advantageous form of design of the invention, the feature is provided that the electrical heating device is provided integrally with the mixing chamber.

In the case of the form of design that has just been mentioned, the feature can advantageously be provided that the foam structure of the electrical heating device is arranged directly at the anode outlet and that it essentially occupies the entire cross-section of the anode outlets of all the fuel cells in the fuel cell stack, and simultaneously forms at least a portion of the mixing volume of the mixing chamber.

In the case of the form of design that has just been mentioned, the feature is advantageously provided that the gas stream comprising spent anode gas, which leaves the anode outlets of the fuel cells, enters the mixing volume of the mixing chamber from a first direction, and that the stream of mixed in cathode gas enters the mixing volume of the mixing chamber from a second direction, and that the mixed streams of spent anode gas and cathode gas enter the mixing volume of the mixing chamber in a third direction.

In accordance with a preferred form of design of the fuel cell arrangement in accordance with the invention, the feature is provided that one or more first segments of the aforementioned individual segments of the electrical heating device are arranged in the gas stream comprising the cathode gas, which is admitted to the mixing chamber, and that one or more second segments of the individual segments of the electrical heating device are arranged in the gas stream comprising the spent anode gas, which leaves the anode outlets, whereby either the stream of spent anode gas alone or the streams of spent anode gas and mixed in cathode gas together flow through the second segments.

In accordance with an advantageous further development of the invention, the individual segments of the electrical heating device are formed from sheets comprising electrically conducting foam material, whereby these sheets are arranged parallel to one another.

In accordance with an especially advantageous form of design of the invention, the feature is provided that one or more fuel cell stacks are arranged in a thermally insulating housing, which surrounds the flow pathways of the cathode gas and the fuel gas, whereby the fuel cell stack(s) and the electrical heating device are linked to one another and are arranged in amalgamated form in the thermally insulating protective housing.

In accordance with an advantageous further development of the invention, the feature is provided that a catalytic combustion device, for after-burning the combustible residual components of the spent fuel gas that leaves the anode outlets, is connected to the fuel cells' anode outlet and arranged downstream thereof.

In accordance with an additional aspect of the invention, the feature is provided that the catalytic combustion device is formed from a catalytic coating on the foam structure of the electrical heating device.

Examples of designs of the invention will be elucidated in the following sections by means of the drawings.

The following aspects are shown.

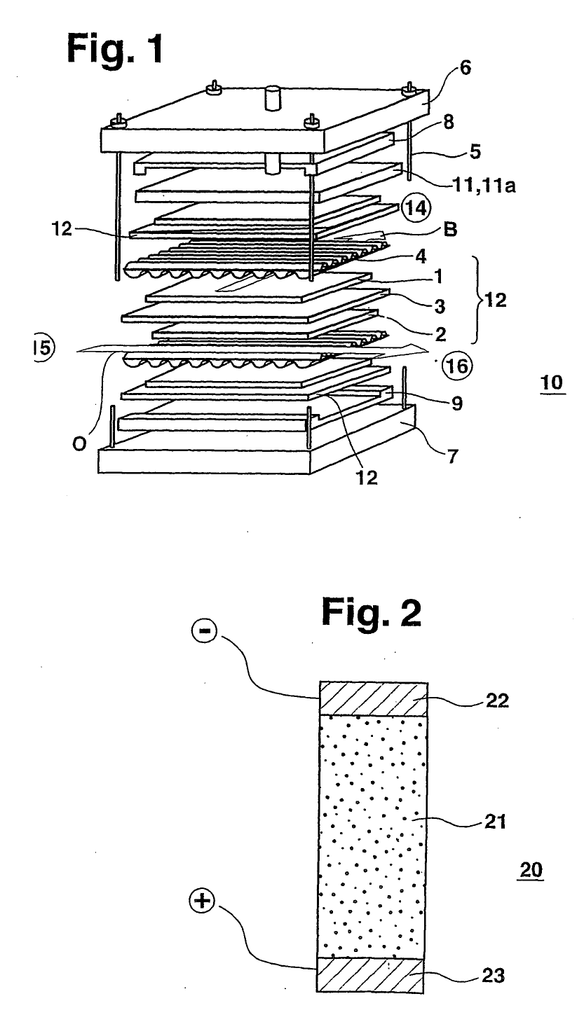

FIG. 1, in schematically drawn form, shows a perspective, exploded view of a fuel cell arrangement with fuel cells that are arranged in the form of a stack, whereby, for purposes of improved clarity, only a few of the fuel cells have been illustrated that are contained in the fuel cell stack;

FIG. 2, on a larger scale in schematically drawn form, shows an electrical heating device in accordance with one example of a design of the invention;

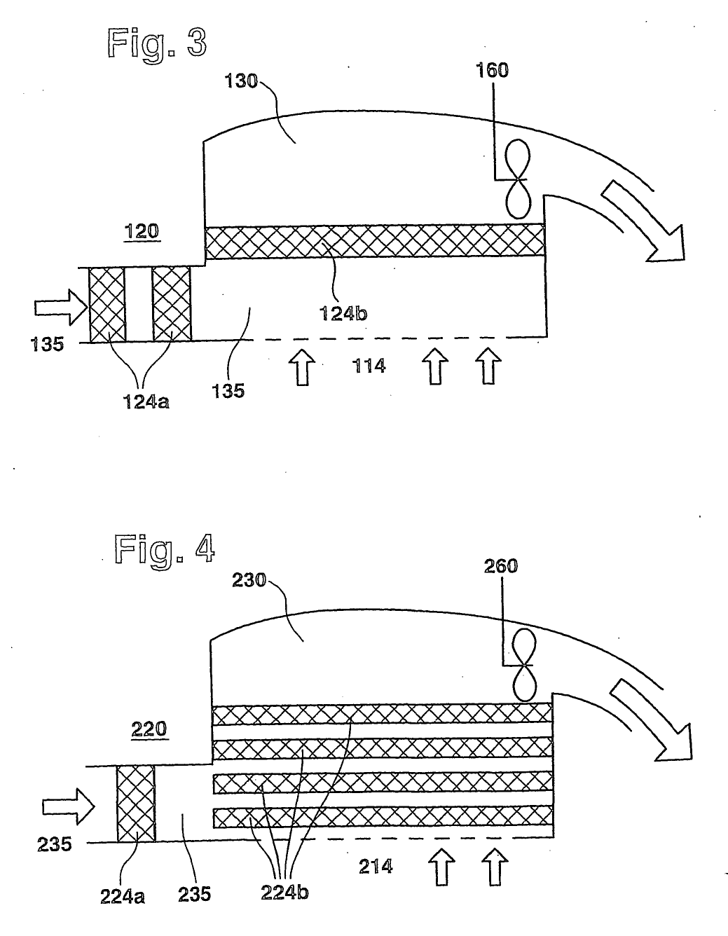

FIG. 3, in a schematically drawn view, shows an electrical heating device in accordance with an additional example of a design of the invention;

FIG. 4, in a schematically drawn view, shows an electrical heating device in accordance with yet another example of a design of the invention;

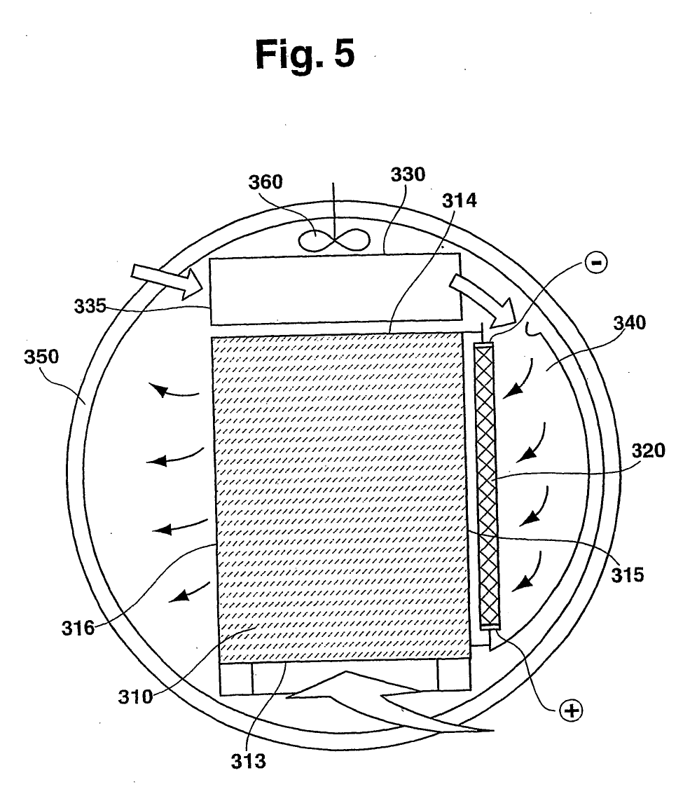

FIGS. 5, 6, and 7, in the form of a plan view, each show schematically drawn illustrations of fuel cell arrangements in accordance with three additional examples of designs of the invention, whereby a fuel cell stack has been arranged in a thermally insulating protective housing in each of the examples of designs.

In FIG. 1, which generally shows a schematically drawn, perspective, exploded view of a fuel cell arrangement, the reference number 10 signifies a fuel cell stack that comprises a plurality of fuel cells 12 that each contain an anode 1, a cathode 2, and an electrolyte matrix 3 that is arranged between them. Adjacent fuel cells 12 are separated from one another by bipolar sheets 4 that serve for leading, separately from one another, the streams of fuel gas B and cathode gas or oxidation gas O respectively over the anode 1 or the cathode 2 of adjacent fuel cells. In this regard, the anode 1 and the cathode 2 of adjacent fuel cells are separated from one another, using gas engineering techniques, by the bipolar sheets 4, but they are simultaneously electrically contacted by the bipolar sheets 4 or, respectively, by current collectors that are contained in them. The fuel cell stack 10 that contains a plurality of such fuel cells 12—of which only a few are illustrated in the diagram for purposes of clarity—is braced by tensile rods 5 that operate in conjunction with end plates 6, 7 at the ends of the fuel cell stack.

Fresh fuel gas is admitted to the fuel cells 12, namely to the anodes 1 at an anode inlet 13, and spent fuel gas is carried away from the anodes 1 at an anode outlet 14 of these fuel cells. Correspondingly, fresh fuel gas is admitted to the fuel cells 12, namely to the cathodes 2 at a cathode inlet 15, and spent fuel gas is carried away from the cathodes 2 at a cathode outlet 16 of these fuel cells.

A fuel cell stack 310; 410; 510 is, in each case, respectively arranged in a protective housing 350; 450; 550 in the examples of designs that are illustrated in FIGS. 5 through 7, whereby the protective housing thermally insulates the fuel cell stack 310, 410; 510 from the surroundings, and it surrounds or defines flow pathways for the fuel gas and the cathode gas. In the case of these examples of designs, a stream of cathode gas is circulated inside the protective housing 350; 450; 550 by means of a blower device 360; 460; 560, whereby the stream of cathode gas, which exits the fuel cell stack 310; 410; 510 at the cathode outlet 316; 416; 516 and re-enters it at the cathode inlet 315; 415; 515, experiences mixing in of the stream of burned fuel gas that is carried away from the anode outlet 314; 414; 514. The fuel gas is admitted to the fuel cell stack 310; 410; 510 at an anode inlet 313; 413; 513 that is sealed off from the interior of the protective housing 350; 450; 550. Such a fuel cell arrangement, which is accommodated in a thermally

insulating protective housing that [typo] surrounds the streams of fuel gas and cathode gas, is termed a “hot module”.

In addition, an electrical heating device 320; 420; 520 is shown in FIGS. 5, 6, and 7, whereby this heating device serves for heating the gas stream comprising cathode gas and/or fuel gas.

In a quite general way, FIG. 2 shows such a heating device 20 that is formed by a structure comprising an electrically conducting foam material. Such a foam material can comprise high-grade steel, especially FeCrAlY, or steel, or a conducting ceramic, or another suitable electrically conducting material. The foam structure can be manufactured by a casting process combined with foam generation within the material in a way that is known in the prior art.

The structure of the electrically conducting material, which forms the heating device 20, is provided with electrical connections 22, 23 that are capable of being connected to a supply of electric current in order to supply the necessary electric current to the electrical heating device 20.

In the case of the two examples of designs that are depicted here, and as shown in FIGS. 3 and 4, the electrical heating device 120; 220 comprises several individual segments 124a, 124b; 224a, 224b that are each provided with electrical connections (not specifically illustrated), whereby the gas that is to be heated, namely the spent fuel gas, which is released from an anode outlet 114; 214, and a stream of cathode gas, which is mixed in at a mixing inlet 135; 235, flow through these segments. In this case, the segments 124a; 224a, which form the first segments through which the stream of cathode gas flows, of [sic; and?] the segments 124b; 224b, which form the second segments through which the stream of spent gas flows that has emerged from the anode outlet 114; 214 (together, if applicable, with the mixed in cathode gas as well), are arranged at different locations within the gas stream that is to be heated. As shown, the respective segments 124a; 224a, 124b; 224b each have connections that are electrically separated from one another, and that are capable of being connected, separately from one another as required, to the supply of electric current (not shown).

In the case of the two examples of designs that are illustrated in FIG. 3 and FIG. 4, the segments 124a, 124b; 224a, 224b of the electrical heating device 120; 220 are formed from sheets that comprise the electrically conducting foam material. In the case of the example of a design in FIG. 3, two first segments 124a are arranged parallel to one another in the form of such sheets; three second segments 224b are arranged in the form of such parallel sheets in the case of the example of a design in FIG. 4.

In the case of the example of a design that is shown in FIG. 3, the entire gas stream that comprises spent fuel gas, which is released from the anode outlet 114, and cathode gas, which is admitted to the mixing inlet 135, is led through the second segment 124b; in the case of the example of a design that is shown in FIG. 4, however, mixing of the two designated gas streams takes place in such a way that these streams are distributed over the plurality of second segments 224b.

As can be seen from FIGS. 5, 6, and 7, which were addressed previously, the electrical heating device 320; 420; 520 is generally provided in the gas stream prior to the cathode inlet 315; 415; 515 in order to heat the cathode gas, which is to be admitted to the cathodes of the fuel cells, mixed in with the spent fuel gas that is released from the anode outlet 314; 414; 514. Thus the electrical heating device 320; 420; 520 is generally arranged in a gas carrying pathway 340; 440; 540 after the anode outlet 314; 414; 514 and prior to the cathode inlet 315; 415; 515, whereby this gas carrying pathway is surrounded or defined by the thermally insulating protective housing 350; 450; 550.

In addition, a mixing chamber 330; 430; 530 is provided in the designated gas carrying pathway 340; 440; 540 between the anode outlet 314; 414; 514 and the cathode inlet 315; 415; 515, whereby the stream of spent fuel gas, which leaves the anode outlet 314; 414; 514, is mixed in with the circulating stream of cathode gas in the mixing chamber prior to being admitted to the cathode inlet 315; 415; 515. Quite generally, the electrical heating device 320; 420; 520 is arranged in some way or other, together with the mixing chamber 330; 430; 530, in the gas stream between the anode outlet 314; 414; 514 and the cathode inlet 315; 415; 515.

In the case of the example of a design that is illustrated in FIG. 5, the electrical heating device 320 is arranged directly prior to the cathode inlet 315, whereby the foam structure of the electrical heating device 320 essentially occupies the entire cross-section of the cathode inlet 315 of all the fuel cells in the fuel cell stack 310.

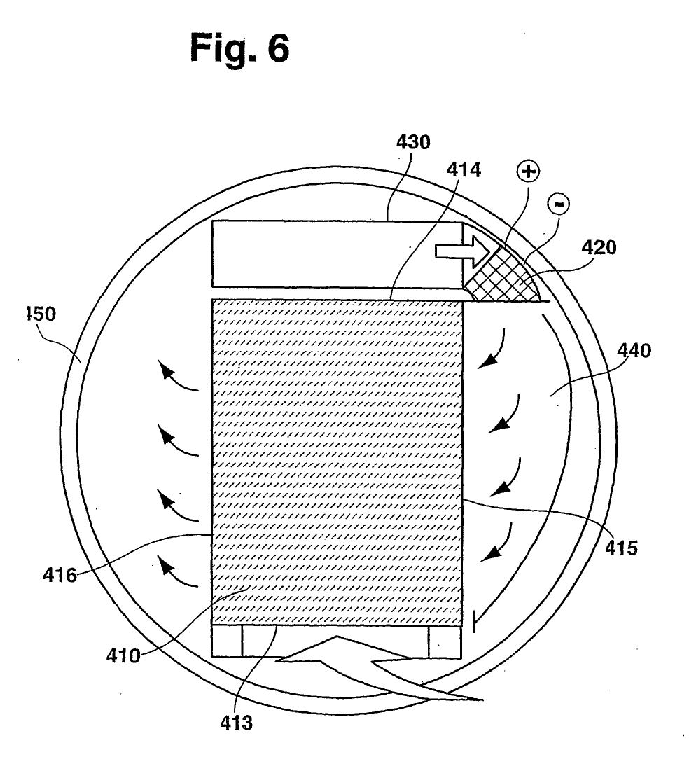

In the case of the example of a design that is illustrated in FIG. 6, however, the electrical heating device 420 is connected to the outlet of the mixing chamber 430 and arranged downstream thereof.

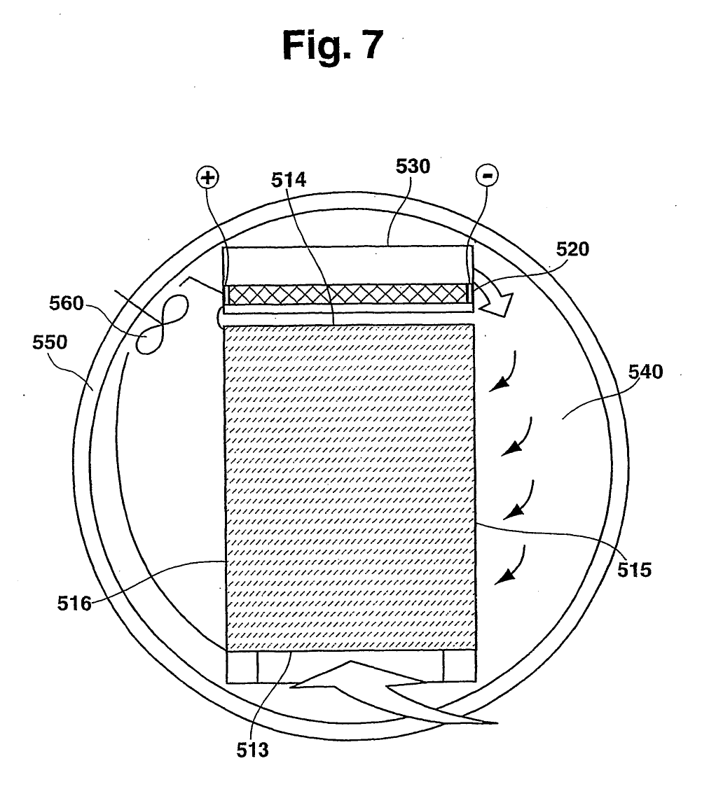

In the case of the example of a design that is illustrated in FIG. 7, the electrical heating device 520 is provided integrally with the mixing chamber 530, i.e. the electrical heating device 520 and the mixing chamber 530 are provided, in a combined manner, in the form of a communal component.

Returning once again to FIGS. 3 and 4, which can be regarded as forms of designs of such combinations of the mixing chamber and the electrical heating device, it can be seen that the foam structure of the electrical heating device—which is provided collectively here with the respective reference numbers 120 or 220—is arranged essentially directly at the anode outlet—which is provided here with the respective reference numbers 114 or 214—occupies essentially the entire cross-section of the anode outlet 114; 214 of all the fuel cells in the fuel cell stack, and simultaneously forms at least a portion of the mixing volume of the mixing chamber 130; 230, namely in the form of the second segments 124b; 224 [sic; 224b?] of the electrical heating device 120; 220.

It can also be seen from FIGS. 3 and 4 that the gas stream comprising the spent anode gas, which leaves the anode outlets 114; 214 of the fuel cell stack, enters the mixing volume of the mixing chamber 130; 230 from a first direction, and that the stream of cathode gas, which is mixed therewith, enters the mixing volume of the mixing chamber 130; 230 in a second direction from the mixing inlet 135; 235. The mixed streams of spent anode gas and cathode gas leave the mixing volume of the mixing chamber 130; 230 in a third direction in order to be admitted, from there, to the cathode inlet (not illustrated) of the fuel cell arrangement.

A catalytic coating on the foam structure of the electrical heating device 120; 220; 320; 420; 520 forms a catalytic combustion device by means of which after-burning takes place of combustible residual components of the spent fuel gas that leaves the anode outlet 114; 214; 314; 414; 514. In the case of the examples of designs of the electrical heating device 120; 220 that are illustrated in FIGS. 3 and 4, such a catalytic coating needs to be provided only on the second segments 124b or 224b, through which the spent fuel gas flows, but not on the first segments 124a; 224a, whereby the circulating stream of cathode gas flows through these first segments, but the anode gas does not.

Thus the electrical heating device, which has been provided in such a way with a catalytic coating, functions as an electrical heating device for starting up the fuel cell arrangement and also as a catalytic combustion device for after-burning the anode side exhaust gases, and it also functions as a static mixer for intimately mixing the streams of anode exhaust gas and cathode gas.

### List of Reference Numbers

| | |
|---|---|
| 1 | anode |
| 2 | cathode |
| 3 | electrolyte matrix |
| 4 | bipolar sheet |
| 5 | tensile rod |
| 6 | end plate |
| 7 | end plate |
| 8 | insulation sheet |
| 9 | insulation sheet |
| 10; 110; 210; 310; 410; 510 | fuel cell stack |
| 12 | fuel cell |
| 13; 313; 413; 513 | anode inlet |
| 14; 114; 214; 314; 414; 514 | anode outlet |
| 15; 315; 415; 515 | cathode inlet |
| 16; 316; 416; 516 | cathode outlet |
| 20; 120; 220; 320; 420; 520 | electrical heating device |
| 21 | foam structure |
| 22 | electrical connection |
| 23 | electrical connection |
| 124a; 224a | segment (first) |
| 224b [sic; 124b?]; 224b | segment (second) |
| 130; 230; 330; 430; 530 | mixing chamber |
| 135; 235; 335; 435; 535 | mixing inlet |
| 340; 440; 540 | gas carrying pathway |
| 350; 450; 550 | protective gas housing |
| 360; 460; 560 | housing device |
| B | fuel gas |
| O | cathode gas |

1. Fuel cell arrangement with fuel cells (12) that are arranged in the form of a fuel cell stack (10; 110; 210; 310; 410; 510), whereby the fuel cells each contain an anode (1), a cathode (2), and an electrolyte matrix (3) that is arranged between them, together with an anode inlet (13; 313; 413; 513) for admitting fresh fuel gas to the anodes (1), and an anode outlet (14; 114; 214; 314; 414; 514) for carrying away spent fuel gas from the anodes (1), together with a cathode inlet (15; 315; 415; 515) for admitting fresh cathode gas to the cathodes (2), and a cathode outlet (16; 316; 416; 516) for carrying away spent cathode gas from the cathodes (2), as well as an electrical heating device (20; 120; 220; 320; 420; 520) in order to heat the cathode inlet gas, characterized in that the electrical heating device (20; 120; 220; 320; 420; 520) is formed from a structure comprising an electrically conducting foam material, whereby the gas, which is to be heated, flows through this structure, and whereby this structure is provided with electrical connections (22; 23) for connection to a supply of electric current.

2. Fuel cell arrangement in accordance with claim 1, characterized in that the foam structure of the electrical heating device (20; 120; 220; 320; 420; 520) comprises high grade steel, preferably FeCrAlY, or steel, or a conducting ceramic.

3. Fuel cell arrangement in accordance with claim 1 or 2, characterized in that the electrical heating device (20; 120; 220; 320; 420; 520) comprises several individual segments (124a, 124b; 224a, 224b) that have each been provided with electrical connections (22, 23), whereby the gas, which is to be heated, flows through these segments.

4. Fuel cell arrangement in accordance with claim 3, characterized in that the segments (124a, 124b; 224a, 224b) of the electrical heating device (20; 120; 220; 320; 420; 520) are arranged at different locations within the gas stream that is to be heated.

5. Fuel cell arrangement in accordance with claim 3 or 4, characterized in that the segments (124a, 124b; 224a, 224b) of the electrical heating device (20; 120; 220; 320; 420; 520) each have connections (22, 23), which are electrically separated from one another, whereby these connections are capable of being connected, separately from one another as required, to the supply of electric current.

6. Fuel cell arrangement in accordance with one of the claims 1 through 5, characterized in that the electrical heating device (320; 420; 520) is arranged in the gas stream prior to the cathode inlet (315; 415; 515) in order to heat the cathode gas that is to be admitted to the cathodes (2) of the fuel cells (12).

7. Fuel cell arrangement in accordance with claim 6, characterized in that the cathode outlet [sic; anode outlet?] (314; 414; 514) is connected to the cathode inlet (315; 415; 515) via a gas carrying pathway (340; 440; 540) in order to admit at least a portion of the spent fuel gas to the cathodes (2) of the fuel cells (12), and that the electrical heating device (320; 420; 520) is arranged in the gas carrying pathway (340; 440; 540) after the anode outlet (314; 414; 514) and prior to the cathode inlet (315; 415; 515).

8. Fuel cell arrangement in accordance with claim 7, characterized in that a mixing chamber (330; 430; 530) is provided in which, prior to admission to the cathode inlet (315; 415; 515), the cathode gas is mixed with the stream of spent fuel gas that leaves the anode outlet (314; 414; 514), whereby this mixing chamber is provided in the gas carrying pathway (340; 440; 540) between the anode outlet (314; 414; 514) and the cathode inlet (315; 415; 515), and in that the electrical heating device (320; 420; 520), together with the mixing chamber (330, 430, 530), is arranged in the gas stream between the anode outlet (314; 414; 514) and the cathode inlet (315; 415; 515).

9. Fuel cell arrangement in accordance with claims 7 and 8, characterized in that the electrical heating device (320) is arranged directly prior to the cathode inlet (315).

10. Fuel cell arrangement in accordance with claim 9, characterized in that the foam structure of the electrical heating device (320) occupies essentially the entire cross-section of the cathode inlets (315) of all the fuel cells (12) in the fuel cell stack (310).

11. Fuel cell arrangement in accordance with claims 7 and 8, characterized in that the electrical heating device (420) is arranged at the outlet of the mixing chamber (430).

12. Fuel cell arrangement in accordance with claims 7 and 8, characterized in that the electrical heating device (520) is provided integrally with the mixing chamber (530).

13. Fuel cell arrangement in accordance with claim 12, characterized in that the foam structure of the electrical heating device (120; 220; 520) is arranged directly at the anode outlet (114; 214; 514) and essentially occupies the entire cross-section of the anode outlets (114; 214; 514) of all the fuel cells in the fuel cell stack, and it simultaneously forms at least a portion of the mixing volume of the mixing chamber (130; 230; 530).

14. Fuel cell arrangement in accordance with claim 13, characterized in that the gas stream comprising spent anode gas, which leaves the anode outlets (114; 214; 514) of the fuel cells, enters the mixing volume of the mixing chamber (130; 230; 530) from a first direction, and in that the stream of mixed in cathode gas enters the mixing volume of the mixing chamber (130; 230; 530) from a second direction, and in that the mixed streams of spent anode gas and cathode gas enter the mixing volume of the mixing chamber (130; 230; 530) in a third direction.

15. Fuel cell arrangement in accordance with claims 12, 13, or 14 in combination with claims 3, 4, or 5, characterized in that one or more first individual segments (124a; 224a) of the electrical heating device (120; 220) are arranged in the gas stream comprising the cathode gas that is admitted to the mixing chamber (130; 230), and that one or more second individual segments (124b; 224b) of the electrical heating device (120; 220) are arranged in the gas stream comprising the spent anode gas that leaves the anode outlets (114; 214), whereby either the stream of spent anode gas alone or the streams of spent anode gas and mixed in cathode gas flow through the second segments (124b; 224b).

16. Fuel cell arrangement in accordance with one of the claims 3 through 15, characterized in that the individual segments (124a, 124b; 224a, 224b) of the electrical heating device (120; 220) are formed from sheets comprising the electrically conducting foam material, whereby these sheets are arranged parallel to one another.

17. Fuel cell arrangement in accordance with one of the claims 1 through 16, characterized in that one or more fuel cell stacks (310; 410; 510) are arranged in a thermally insulating protective housing (350; 450; 550), which surrounds the flow pathways of the cathode gas and fuel gas, and that the fuel cell stack(s) (310; 410; 510) and the electrical heating device (320; 420; 520) are linked to one another and are arranged, in amalgamated form, in the thermally insulating protective housing (350; 450; 550).

18. Fuel cell arrangement in accordance with one of the claims 1 through 17, characterized in that a catalytic combustion device for after-burning the combustible residual components of the spent fuel gas, which leaves the anode outlets (114; 214; 314; 414; 514), is provided and that it is connected to the anode outlet (114; 214; 314; 414; 514) and arranged downstream thereof.

19. Fuel cell arrangement in accordance with claim 18, characterized in that the catalytic combustion device is formed from a catalytic coating on the foam structure of the electrical heating device (120; 220; 320; 420; 520).
